(19) United States
(12) Patent Application Publication
(10) Pub. No.: US 2017/0161065 A1
(43) Pub. Date: Jun. 8, 2017

(54) Generating Code Coverage Data for use with a Computing Device and System

(71) Applicant: Google Inc., Mountain View, CA (US)

(72) Inventor: Joseph Benjamin Gruver, Mountain View, CA (US)

(73) Assignee: Google Inc., Mountain View, CA (US)

(21) Appl. No.: 14/033,658

(22) Filed: Sep. 23, 2013

Related U.S. Application Data
(60) Provisional application No. 61/716,507, filed on Oct. 20, 2012.

(51) Int. Cl. G06F 9/30

(52) U.S. Cl. CPC G06F 9/30003

(57) ABSTRACT

Methods and systems for generating code coverage are described. An example method may include receiving a set of instructions to be executed by a computing system in one of multiple execution modes. The method may also include determining a mapping between each instruction of the set of instructions and a corresponding value of an array of values. Additionally, the method may include executing instructions of the set of instructions in one or more of the multiple execution modes, and based on the executing, for each respective instruction that is executed in the first mode, modifying a particular value of the array that corresponds to the respective instruction. Based on the array of values and the mapping, the computing system may determine which instructions of the set of instructions were executed at least once.

### CROSS-REFERENCE TO RELATED APPLICATIONS

This application claims the benefit of U.S. Provisional Application No. 61/716,507 filed on Oct. 20, 2012, the entirety of which is herein incorporated by reference.

### BACKGROUND

When software, such as a collection of computer code written in one of any number of programming languages, is developed, investigations are conducted to provide information about the quality of the software. One purpose of the investigations may include detecting any software failures so that any defects can be rectified. For instance, computer code may be executed in various environments and conditions while examining the aspects of the code to verify accuracy of the results of the execution. A common measure used in software testing to describe the degree to which the source code of a program has been tested is code coverage.

Code coverage may indicate how well the program is exercised by a collection of test cases according to one or more coverage criteria. For example, coverage criteria may describe a level of coverage at the function level (i.e., has each function in the program been called?), statement level (i.e., has each node in the program executed?), and/or decision level (i.e., has every branch/edge in the program been executed?). By analyzing code coverage, test engineers can determine which areas of a program have not been exercised and derive additional test cases if necessary to exercise any untested code.

### SUMMARY

In one example aspect, a method is provided that comprises receiving a set of instructions to be executed by a computing system in one of multiple execution modes. The computing system may be configured to execute one or more individual instructions of the set of instructions in a higher performance mode after the individual instructions have been executed at least once in a first mode. In the higher performance mode, the computing system may be configured to execute the individual instructions with a faster speed of execution than in the first mode. The method may also include determining, by the computing system, a mapping between each instruction of the set of instructions and a corresponding value of an array of values. For instance, a value of the array of values may indicate whether a given instruction has been executed by the computing system. Additionally, the method may include executing, by the computing system, instructions of the set of instructions in one or more of the multiple execution modes. The method may further include, based on the executing, for each respective instruction that is executed in the first mode, modifying, by the computing system, a particular value of the array of values that corresponds to the respective instruction. According to the method, based on the array of values and the mapping, the computing system may determine which instructions of the set of instructions were executed at least once by the computing system.

In another example aspect, a computer-readable medium having stored thereon instructions that, when executed by a computing device, cause the computing device to perform functions is provided. The functions may include receiving portable code to be executed in one of multiple execution modes. The computing device may be configured to execute one or more individual instructions of the portable code in a higher performance mode after the individual instructions have been executed at least once in a first mode. In the higher performance mode, the computing device may be configured to execute the individual instructions with a faster speed of execution than in the first mode. The functions may also include determining a mapping between each instruction of the portable code and a corresponding value of an array of values. For instance, a value of the array of values may indicate whether a given instruction has been executed by the computing system. The functions may further include executing instructions of the portable code in one or more of the multiple execution modes, and based on the executing, for each respective instruction that is executed in the first mode, modifying a particular value of the array of values that corresponds to the respective instruction. According to the functions, based on the array of values and the mapping, a determination of instructions of the portable code that were executed at least once by the computing device may be made.

In another example aspect, a computing system that comprises a memory and at least one processor is provided. The at least one processor may be coupled to the memory and may be configured to host a virtual machine. The computing system may also include instructions stored in the memory that, when executed by the virtual machine, cause the virtual machine to perform functions. The functions may include receiving portable code to be executed in one of multiple execution modes. The virtual machine may be configured to execute one or more individual instructions of the portable code in a higher performance mode after the individual instructions have been executed at least once in a first mode. In the higher performance mode, the virtual machine may be configured to execute individual instructions with a faster speed of execution than in the first mode. The functions may further include determining a mapping between each instruction of the portable code and a corresponding value of an array of values. For instance, a value of the array of values may indicate whether a given instruction of the portable code has been executed by the computing system. The functions may also include modifying, based on the mapping, particular values of the array of values that correspond to particular instructions of the portable code as the particular instructions are executed by the virtual machine. Additionally, the functions may include determining which instructions of the portable code were executed at least once by the computing system based on the array of values and the mapping.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates an example system.

FIG. 2 is a conceptual flow diagram illustrating an example compilation of source code for a virtual machine.

FIG. 3 is a block diagram of an example method for generating code coverage.

FIGS. 4A and 4B are conceptual illustrations of example mappings between a set of instructions and arrays of values.

FIG. 5 is a functional block diagram illustrating an example computing device used in a computing system that is arranged in accordance with at least some embodiments described herein.

FIG. 6 is a schematic illustrating a conceptual partial view of an example computer program product that includes a computer program for executing a computer process on a computing device, arranged according to at least some embodiments presented herein.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

This disclosure may disclose, inter alia, methods and systems for generating code coverage. According to an example method, a set of instructions to be executed by a computing system in one or more of multiple execution modes may be received. The set of instructions may be an executable program for which code coverage data is desired. In the example method, the computing device may be configured to execute one or more individual instructions of the set of instructions in a higher performance mode after the individual instructions have been executed at least once in a first mode. As an example, the first mode may be an interpreter mode in which portable code is interpreted by the computing system and executed, while the higher performance mode may involve executing individual instructions that have been compiled to native machine code. Executing the native machine code may also be performed with a faster speed of execution than interpreting the portable code. Thus, in some instances, in the higher performance mode, the computing system may execute the individual instructions with a faster speed of execution than in the first mode.

The computing system may also be configured to determine a mapping between each instruction of the set of instructions and a corresponding value of an array of values that indicate whether each instruction has been executed by the computing system. For instance, the computing system may analyze the set of instructions to determine how many instructions are present and allocate a block of memory with enough space to store one value (e.g., a Boolean value) per instruction. As the computing system is executing the set of instructions, the computing system may be configured to determine when individual instructions are executed in the first mode. Based on the execution, the computing system may modify a particular value of the array that corresponds to the respective instruction. For example, before, during, or after the execution of a given instruction in the first mode, the computing system may modify a value in the array that corresponds to the given instruction to indicate that the given instruction has been executed. After executing instructions of the set of instructions, the computing system may determine, based on the array of values and the mapping, which instructions were executed at least once by the computing system.

In an example embodiment, the method may be applicable to tracking which instructions, of a set of instructions to be executed by a virtual machine, were executed at least once by the virtual machine. In one example, the virtual machine may have multiple execution modes, such that instructions are initially executed in a first mode or set of modes, and subsequently, instructions of the set of instructions that are heavily used or performance critical may be run in a different, presumably higher performance execution mode or set of modes. The virtual machine may be configured such that a Boolean flag for each instruction is generated and initially set to false. The Boolean flag may be toggled to true by the virtual machine when an instruction is executed in the first mode (or set of modes). However, when the instruction is executed in the higher performance mode (or set of modes), the virtual machine may be configured to execute the instruction without tracking and modifying the Boolean flag.

In some cases, removing the additional step of tracking which instructions are executed during the higher performance mode may remove any performance penalty (e.g., delay) associated with generating code coverage while still accurately determining which instructions of the set of instructions were executed at least once. For instance, the example method may take advantage of a virtual machine configuration where all instructions to be executed are first executed in the first mode. By modifying the virtual machine such that instructions may be tracked during the first mode (e.g., an interpreter mode) without modifying the higher performance mode, any delay associated with generating coverage data during the higher performance mode may be removed.

Thus, in some examples, the described systems and methods may facilitate generating code coverage data while minimizing the runtime performance of a computing system due to tracking the coverage data. Additional functionalities and examples of the described methods and systems are also described hereinafter with reference to the accompanying figures.

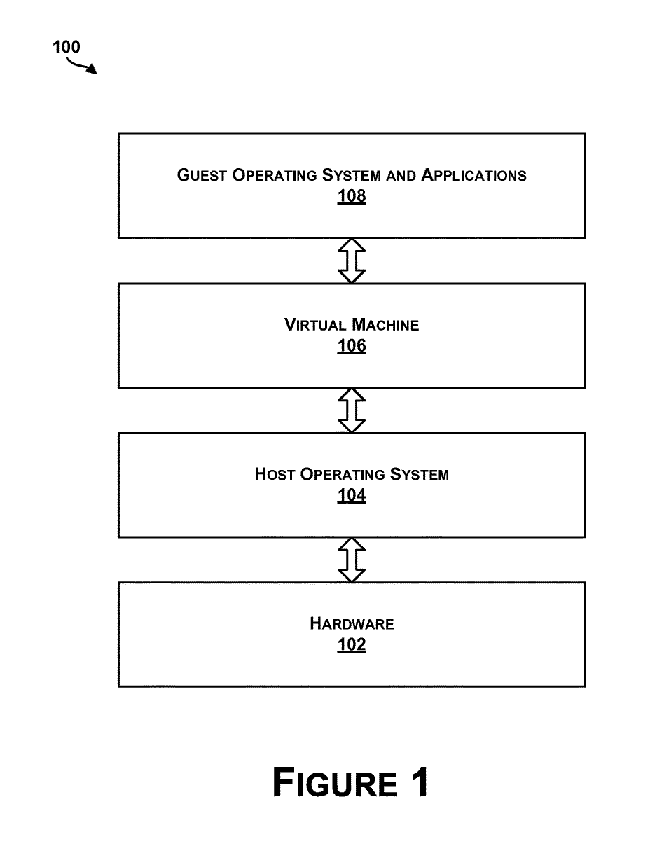

Referring now to the figures, FIG. 1 illustrates example system architecture 100 of a computing system. As shown in FIG. 1, the system architecture 100 may include a hardware layer 102, host operating system layer 104, virtual machine layer 106, and guest operating system and applications layer 108.

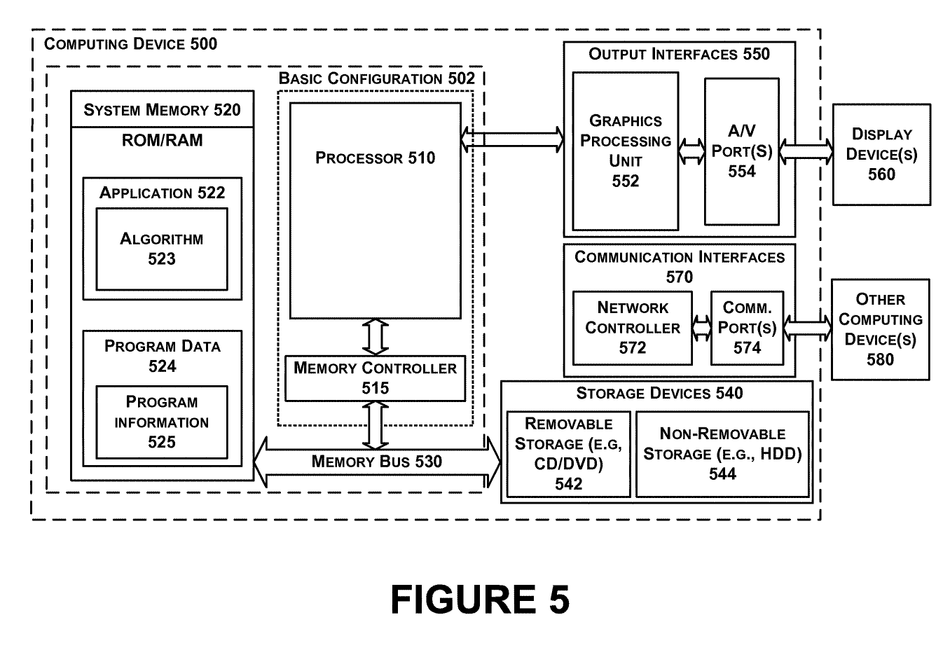

The hardware layer 102 may represent a physical computing device, such as a personal computer, desktop computer, laptop computer, tablet computer, server, mobile device, or any other type of computing device. For instance, the computing device may take the form of the computing device 500 of FIG. 5 or components of the computing device 500. Therefore, the hardware layer 102 may include at least one processor coupled to at least one memory. The processor may be any type of processor, such as a microprocessor, digital signal processor (DSP), multicore processor, etc., coupled to the memory 112. The memory may be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

The computing device of the hardware layer 102 may also be configured to provide a host operating system. For instance, the operating system may include a collection of software that manages computer hardware resources of the hardware layer 102 to provide services for computer programs operating within the host operating system layer 104. The host operating system layer 104 may include one or any combination of various operating systems.

The host operating system may also be configured to provide services for the virtual machine layer 106. The virtual machine layer 106 may include one or multiple virtual machines. A virtual machine may be a software implementation of a machine (e.g., a computing device) that executes programs like a physical computing device. In one example, the virtual machine layer 106 may include a process virtual machine (sometimes referred to as an application virtual machine) that is configured to operate as an application within the host operating system. The process virtual machine may be designed to run a single program, for instance. The process virtual machine may also provide a platform-independent programming environment that allows a program to be executed the same way regardless of the underlying physical hardware supporting the virtual machine. The process virtual machine may take the form of a stack machine (e.g., a Java virtual machine) or employ a register-based architecture (e.g., the Dalvik virtual machine). In other examples, the virtual machine layer 106 may include a system virtual machine that provides support for the execution of a complete guest operating system. Thus, the virtual machine layer 106 may provide an environment for a guest operating system or one or more processes within the guest operating system and applications layer 108.

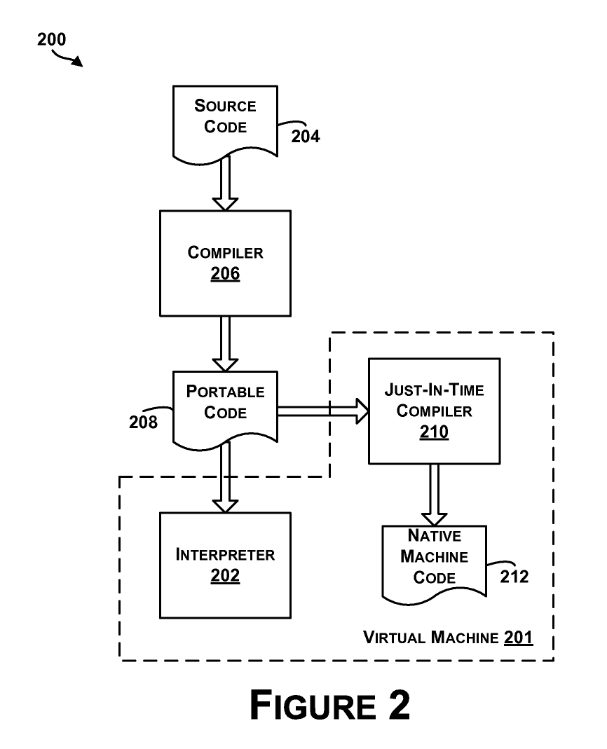

In some examples, the system architecture 100 may support the execution of an instruction or a set of instructions (e.g., computer code) within multiple execution modes. For example, a virtual machine within the virtual machine layer 106 may be configured to execute portable code using an interpreter and also execute just-in-time (JIT) compiled native machine code. FIG. 2 is a conceptual flow diagram 200 illustrating an example compilation of source code for a virtual machine 201.

As shown in FIG. 2, an application to be executed by an interpreter 202 may initially take the form of source code 204. The source code 204 may be a collection of computer instructions that are written using a human-readable computer language. Subsequently, a compiler 206 may compile the source code 204 to portable code 208. As an example, the portable code 208, sometimes referred to as bytecode, may be a form of instruction set designed for efficient execution by the interpreter 202. In one example, the compiler 206 may output bytecode that includes individual instructions such as operation codes (or opcodes) that are one byte in length. Each opcode may correspond to a type of instruction such as a load or store operation, an arithmetic or logic operation, type conversion, stack management, control transfer, etc. Other instructions may require parameters and therefore be multi-byte instructions. In one instance, the portable code may be Java bytecode that is configured to be interpreted by a Java virtual machine. In another instance, Java bytecode may be converted into Dalvik-compatible .dex (Dalvik Executable) files that may be interpreted by the Dalvik virtual machine. In still another instance, the portable code may be bytecode to be executed by a .NET virtual machine.

In one example, the virtual machine 201 may be configured such that each instruction of the portable code 208 is initially interpreted and executed in a first interpreter mode by the interpreter 202. Since bytecode is interpreted, in some instances, the bytecode may be executed more slowly than native machine code which can be executed directly. Native machine code may be executed directly by a computer's central processing unit (CPU). For example, a CPU may have a machine code instruction set in which certain patterns of bits correspond to different commands to the machine. Accordingly, each instruction of the machine code may directly cause a specific operation to be performed by the CPU, leading to faster execution speeds.

In order to improve performance (e.g., speed of execution), a just-in-time compiler 210 may be used to compile one or more code segments of the portable code 208 to native machine code 212. The machine code may be compatible with a CPU, such as a CPU within the hardware layer 102 of FIG. 1. The just-in-time compiler 208 may compile an instruction or multiple instructions to native machine code 212 during the execution of the instruction in the first interpreter mode. Optionally, the just-in-time compiler may compile instructions to machine code before or after execution of the instructions in the first interpreter mode (e.g., or substantially before or substantially after execution). This compilation to machine code can be performed on an individual method or function of the set of instructions or on an arbitrary code fragment, for instance. The compiled native machine code 212 may then be cached and reused for subsequent executions of the instructions (e.g., when a function or method is called again during execution of a set of instructions for a program). In one example, during a first call to a method within a program, as the method is being interpreted and executed in a first mode, the portable code for the method may be just-in-time compiled to native machine code. If the method is called again, the stored native machine code may be executed.

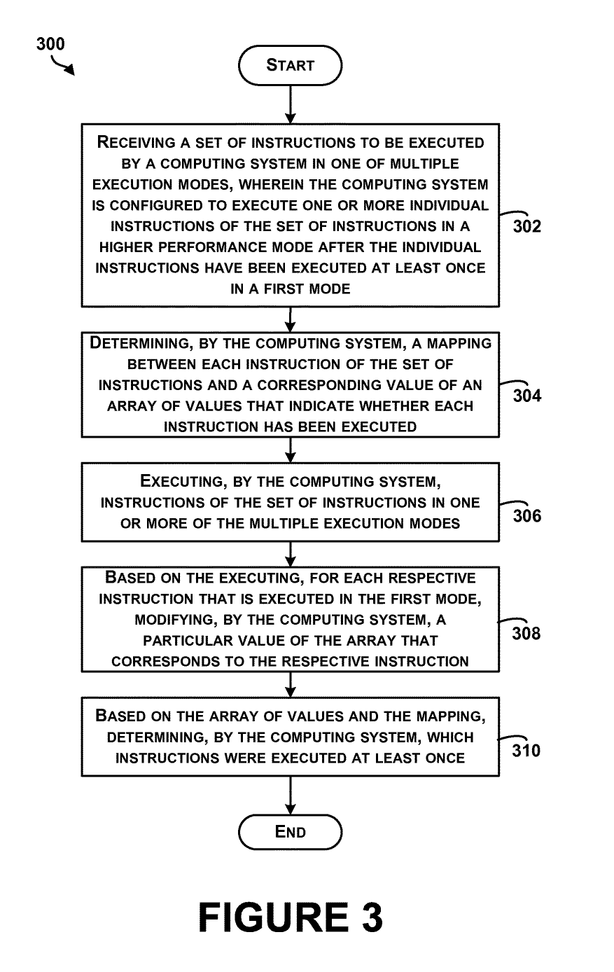

In order to generate code coverage data for a set of instructions executed by a virtual machine, the virtual machine may be modified to track which instructions are executed at least once by the virtual machine. FIG. 3 is a block diagram of an example method 300 for generating code coverage. Method 300 shown in FIG. 3 presents an embodiment of a method that could be used or implemented by the virtual machine layer 106 of FIG. 1, for example, or by components of the virtual machine layer 106 in FIG. 1, or more generally by any virtual machine. Method 300 may include one or more operations, functions, or actions as illustrated by one or more of blocks 302-310. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 300 and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer-readable medium, for example, such as a storage device including a disk or hard drive. The computer-readable medium may include non-transitory computer-readable medium, for example, such as computer-readable media that stores data for short periods of time like register memory, processor cache and random access memory (RAM). The computer-readable medium may also include non-transitory media, such as secondary or persistent long term storage, like read only memory (ROM), optical or magnetic disks, compact-disc read only memory (CD-ROM), for example. The computer-readable media may also be any other volatile or non-volatile storage systems. The computer-readable medium may be considered a computer-readable storage medium, for example, or a tangible storage device.

In addition, for the method 300 and other processes and methods disclosed herein, each block in FIG. 3 may represent circuitry that is wired to perform the specific logical functions in the process.

Initially, at block 302, the method 300 includes receiving a set of instructions to be executed by a computing system in one of multiple execution modes. The computing system may be configured to execute one or more individual instructions of the set of instructions in higher performance mode after the individual instructions have been executed at least once in a first.

As described with respect to FIGS. 1 and 2, the computing system may be a virtual machine configured to execute instructions in multiple modes. For example, the first mode may be an interpreter mode in which portable code is interpreted by the virtual machine (i.e., a bytecode interpreter mode) while the higher performance mode may be a mode in which the virtual machine is configured to execute instructions that have been JIT compiled to native machine code. Thus, the higher performance mode may be a mode in which instructions are executed with a faster speed of execution than in the first mode.

At block 304, the method 300 includes determining, by the computing system, a mapping (or other correlation) between each instruction of the set of instructions and a corresponding value of an array of values that indicate whether each instruction has been executed. For instance, a virtual machine may be configured to determine the number of instructions within a bytecode stream of instructions. In one example, determining the number of instructions may involve parsing bytecode into individual instructions. Based on the number of instructions (e.g., the number of bytecode opcodes), the virtual machine may generate an array of values having at least as many values as the number of instructions. The values may be Boolean values or integer values, for example. The virtual machine may also determine a one-to-one correspondence between each instruction and a respective value in the array of values.

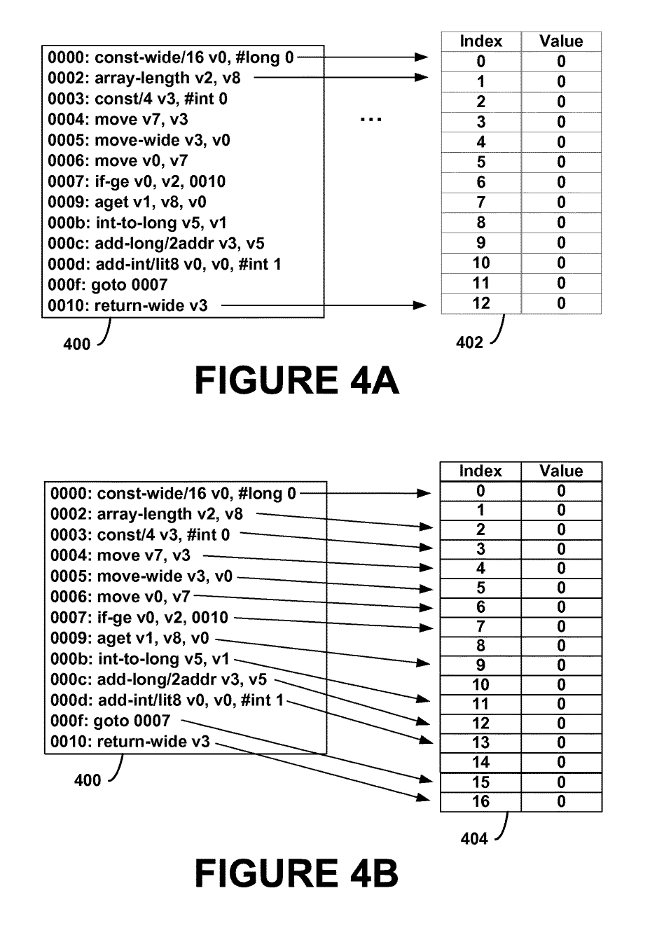

As further examples, FIGS. 4A and 4B are conceptual illustrations of mappings between a set of instructions 400 and arrays of values. The set of instructions 400 represent example compiled bytecode for the programming logic of Table 1 shown below.

TABLE 1

```
public static long sumArray(int[ ] arr) {
  long sum = 0;
  for (int i : arr) {
    sum += i;
  }
  return sum;
}
```

The set of instructions 400 in FIGS. 4A and 4B are shown as parsed individual instructions that include an index of each instruction (represented in hexadecimal format) and an indication of the type of operation. The compiled bytecode (not shown) includes 17 bytecodes, representing 13 individual operations and 4 parameters for summing an array of values via the method shown in Table 1.

As shown in FIG. 4A, in one example, an array of values 402 having as many values as the number of instructions within the set of instructions 400 may be generated. For example, the number of values in the array of values 402 may be equal to the number of opcodes within the bytecode. Each instruction, therefore maps to the array of values 402 based on the position of the opcode with respect to the other opcodes in the set of instructions 400.

As shown in FIG. 4B, in another example, a mapping between the set of instructions 400 and an array of values 404 may be generated based on the indexes of instructions within the set of instructions 400. For example, an opcode at index 0 of the set of instructions 400 maps to a value at index 0 of the array of values 404 while an opcode at index 2 of the set of instructions maps to a value at index 2 in the array of values 404. Note that each instruction is associated with a value in the array of values but some of the values in the array of values (e.g., values at indexes 1, 8, 10, and 14) are not associated with any instructions. This is because some of the instructions within the bytecode for the set of instructions 400 are multi-byte instructions that require parameters (e.g., the first instruction requires a parameter “#long0” that is compiled as a byte at index 1 within the bytecode).

Returning to FIG. 3, at block 306, the method 300 includes executing, by the computing system, instructions of the set of instructions in one or more of the multiple execution modes. For example, instructions of the set of instructions may initially be interpreted and executed in a first mode. During the execution of an instruction or group of instructions of the instruction set in the first mode, the instructions may be just-in-time compiled to native machine code. Subsequently, if any instructions are executed a second time or multiple other times, the compiled native machine code may be executed directly in a higher performance mode.

At block 308, the method 300 includes based on the executing, for each respective instruction that is executed in the first mode, modifying, by the computing system, a particular value of the array that corresponds to the respective instruction. For example, the virtual machine may be configured to modify a value in the array of values before, during, or after the execution of an instruction. In an instance in which the array of values includes Boolean values, the Boolean values may initially be set to false. When an individual instruction is interpreted in the first mode, a corresponding Boolean value may be set to true. In another instance the array of values may be initially set to zero, and when an individual instruction is executed in the first mode, the value corresponding to the individual instruction may be replaced with an integer value that is indicative of the current time. Other example configurations for initializing and modifying the values of the array of values are also possible.

At block 310, the method 300 includes based on the array of values and the mapping, determining, by the computing system, which instructions were executed at least once. If the array of values includes Boolean values, the computing system may determine which values have and/or have not been toggled to true. Since the virtual machine is configured such that if an instruction is executed, it is initially executed in the first mode, any values that have not been set to true correspond to instructions that have not been executed at least once. Based on the mapping between the array of values and the corresponding instructions of the set of instructions, the computing system may identify instructions associated with the values that have not been set to true. Similarly, in other instances, based on the modification of the values and the initial condition of the values, the computing system may be able to determine if and/or when individual instructions were executed.

In some examples, the determined information indicating which instructions have been executed at least once (i.e., the code coverage data) may be stored in a memory or output as a report. For example, the report may be a text report such as a PDF, HTML, or other type of text document indicating which instructions have and/or have not been executed at least once.

In some cases, the example method 300 may be a method that minimizes the performance impact associated with generating code coverage. To illustrate the minimization of performance impact, a comparison of one implementation of the method 300 with another alternative method (that does not minimize performance impact) is described. In an example scenario, without tracking code coverage, a virtual machine may be able to execute a given set of instructions for a program in 100 seconds. Within the 100 seconds, the virtual machine may spend 20% of the time running in interpreter mode, while during the remaining 80% of the time, the virtual machine may be executing instructions in a higher performance mode. According to the alternative method for generating code coverage, coverage data can be generated by instrumenting the bytecode or source code directly. For example, additional logic may be inserted (e.g., around each individual function or code segment) to track which instructions are executed. Because the bytecode or source code is instrumented directly, any JIT compiled code will include the additional logic. Assuming a 20% performance penalty due to the additional logic, generating code coverage data while executing the given set of instructions may yield an additional 20 seconds, such that executing the program and generating code coverage data requires 120 seconds.

According to the example method 300, which generates code coverage data without instrumenting the source code or bytecode, assuming that tracking which instructions are run in the first interpreter mode adds a similar 20% performance penalty, the 20% performance penalty could only accrue during execution in the first mode (i.e., only during 20% or 20 seconds of the 100 seconds spent in the first mode and not during the 80 seconds executed in the higher performance mode). The execution in the higher performance mode may not be subject to the performance penalty because the JIT compiled code is not instrumented or tracked for coverage purposes. Thus, a total performance penalty that is 20% of 20 seconds or 4 seconds results, such that executing the program and generating code coverage data according to the example method 300 requires 104 seconds. Therefore, in the example scenario, the example method 300 reduces the performance penalty due to tracking code coverage data by a factor of five.

FIG. 5 is a functional block diagram illustrating an example computing device 500 used in a computing system that is arranged in accordance with at least some embodiments described herein. The computing device 500 may be implemented to generate code coverage data or perform any of the functions described in FIGS. 1-4. In a basic configuration 502, computing device 500 may typically include one or more processors 510 and system memory 520. A memory bus 530 can be used for communicating between the processor 510 and the system memory 520. Depending on the desired configuration, processor 510 can be of any type including but not limited to a microprocessor (μP), a microcontroller (μC), a digital signal processor (DSP), or any combination thereof. A memory controller 515 can also be used with the processor 510, or in some implementations, the memory controller 515 can be an internal part of the processor 510.

Depending on the desired configuration, the system memory 520 can be of any type including but not limited to volatile memory (such as RAM), non-volatile memory (such as ROM, flash memory, etc.) or any combination thereof. System memory 520 may include one or more applications 522, and program data 524. Application 522 may include an algorithm 523 that is arranged to provide inputs to the electronic circuits, in accordance with the present disclosure. Program data 524 may include program information 525 that could be directed to any number of types of data. For instance, application 520 may execute an algorithm that is configured to generate code coverage data. In some example embodiments, application 522 can be arranged to operate with program data 524 on an operating system.

Computing device 500 can have additional features or functionality, and additional interfaces to facilitate communications between the basic configuration 502 and any devices and interfaces. For example, data storage devices 540 can be provided including removable storage devices 542, non-removable storage devices 544, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer-readable instructions, data structures, program modules, or other data.

System memory 520 and storage devices 540 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media can be part of device 500.

Computing device 500 can also include output interfaces 550 that may include a graphics processing unit 552, which can be configured to communicate to various external devices such as display devices 560 or speakers via one or more A/V ports 554 or a communication interface 570. The communication interface 570 may include a network controller 572, which can be arranged to facilitate communications with one or more other computing devices 580 over a network communication via one or more communication ports 574. The communication connection is one example of a communication media. Communication media may be embodied by computer-readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

Computing device 500 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 can also be implemented as a personal computer, including both laptop computer and non-laptop computer configurations, or a server.

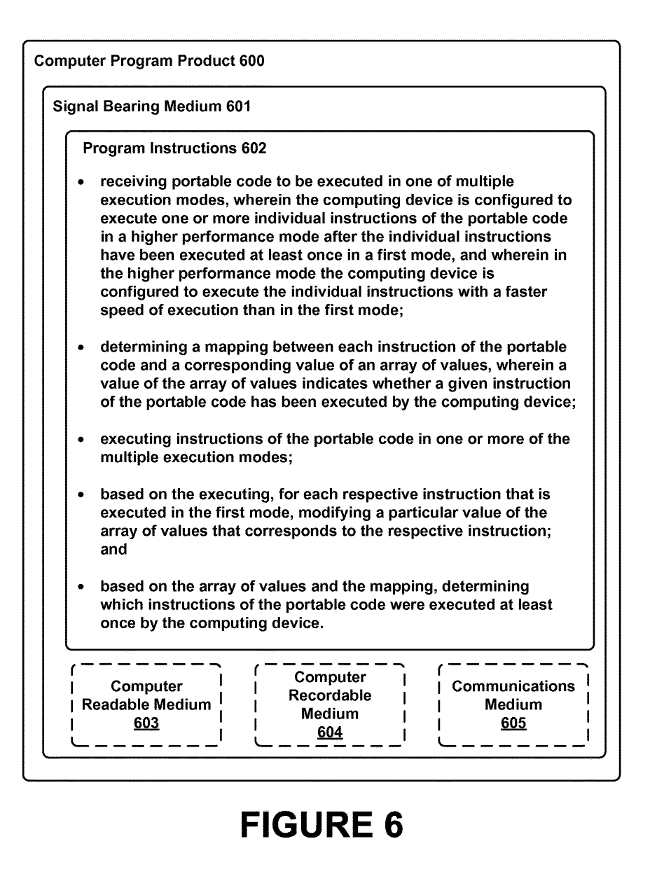

In some embodiments, the disclosed methods may be implemented as computer program instructions encoded on a non-transitory computer-readable storage media in a machine-readable format, or on other non-transitory media or articles of manufacture. FIG. 6 is a schematic illustrating a conceptual partial view of an example computer program product 600 that includes a computer program for executing a computer process on a computing device, arranged according to at least some embodiments presented herein.

In one embodiment, the example computer program product 600 is provided using a signal bearing medium 601. The signal bearing medium 601 may include one or more programming instructions 602 that, when executed by one or more processors may provide functionality or portions of the functionality described above with respect to FIGS. 1-5. In some examples, the signal bearing medium 601 may encompass a computer-readable medium 603, such as, but not limited to, a hard disk drive, a Compact Disc (CD), a Digital Video Disk (DVD), a digital tape, memory, etc. In some implementations, the signal bearing medium 601 may encompass a computer recordable medium 604, such as, but not limited to, memory, read/write (R/W) CDs, R/W DVDs, etc. In some implementations, the signal bearing medium 601 may encompass a communications medium 605, such as, but not limited to, a digital and/or an analog communication medium (e.g., a fiber optic cable, a waveguide, a wired communications link, a wireless communication link, etc.). Thus, for example, the signal bearing medium 601 may be conveyed by a wireless form of the communications medium 605 (e.g., a wireless communications medium conforming with the IEEE 802.11 standard or other transmission protocol).

The one or more programming instructions 602 may be, for example, computer executable and/or logic implemented instructions. In some examples, a computing device such as the computing device 500 of FIG. 5 may be configured to provide various operations, functions, or actions in response to the programming instructions 602 conveyed to the computing device 500 by one or more of the computer-readable medium 603, the computer recordable medium 604, and/or the communications medium 605.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method comprising:
receiving portable code to be executed by a virtual machine in one of multiple execution modes, wherein the virtual machine is configured to execute one or more individual instructions of the portable code in a higher performance mode after the individual instructions have been executed at least once in a first mode, and wherein in the higher performance mode the computing system is configured to execute the individual instructions with a faster speed of execution than in the first mode;
determining, by the virtual machine, the number of instructions within the portable code;
generating, by the virtual machine, an array of values having at least as many values as the number of instructions, wherein each instruction of the portable code is associated with a separate value in the array of values;
determining, by the virtual machine, a mapping between each instruction of the portable code and a corresponding value in the array of values, wherein a value of the array of values indicates whether a given instruction has been executed by the virtual machine;
executing, by the virtual machine, instructions of the portable code in one or more of the multiple execution modes, wherein executing the instructions comprises:
identifying, without referencing the array of values, particular instructions to execute in the higher performance mode,
compiling the identified instructions into native machine code, and
executing, by the virtual machine, the native machine code;
based on the executing, for each respective instruction that is executed in the first mode, modifying, by the virtual machine, a particular value of the array of values that corresponds to the respective instruction;
based on the array of values and the mapping, determining which instructions of the portable code were executed at least once by the virtual machine^{.} and
providing a report indicative of the determined instructions.

2. The method of claim 1, wherein the virtual machine is configured to execute the portable code as an application within a host operating system of a computing system.

3. (canceled)

4. The method of claim 1, wherein the portable code comprises one or more Dalvik Executable files.

5. The method of claim 1, wherein the first mode comprises a bytecode interpreter mode.

6. (canceled)

7. (canceled)

8. The method of claim 1, wherein the array of values comprises an array of Boolean values that are initially set to false, and wherein modifying the particular value of the array comprises setting the particular value to true.

9. The method of claim 1, wherein the array of values comprises an array of integer values, and wherein modifying the particular value of the array comprises setting the particular value to an integer that is indicative of a current time.

10. The method of claim 1, further comprising, for each respective instruction of the portable code, storing information identifying whether the respective instruction was executed at least once by the virtual machine.

11. A non-transitory computer-readable medium having stored thereon instructions that, when executed by a computing device, cause the computing device to perform functions comprising:
receiving portable code to be executed by a virtual machine in one of multiple execution modes, wherein the virtual machine is configured to execute one or more individual instructions of the portable code in a higher performance mode after the individual instructions have been executed at least once in a first mode, and wherein in the higher performance mode the computing device is configured to execute the individual instructions with a faster speed of execution than in the first mode;
determining, by the virtual machine, the number of instructions within the portable code;
generating, by the virtual machine, an array of values having at least as many values as the number of instructions, wherein each instruction of the portable code is associated with a separate value in the array of values;
determining, by the virtual machine, a mapping between each instruction of the portable code and a corresponding value in the array of values, wherein a value of the array of values indicates whether a given instruction has been executed by the computing device;
executing, by the virtual machine, instructions of the portable code in one or more of the multiple execution modes, wherein executing the instructions comprises:
identifying, without referencing the array of values, particular instructions to execute in the higher performance mode,
compiling the identified instructions into native machine code, and
executing, by the virtual machine, the native machine code;
based on the executing, for each respective instruction that is executed in the first mode, modifying, by the virtual machine, a particular value of the array of values that corresponds to the respective instruction;
based on the array of values and the mapping, determining which instructions of the portable code were executed at least once by the virtual machine; and
providing a report indicative of the determined instructions.

12. The non-transitory computer-readable medium of claim 11, wherein the portable code comprises bytecode.

13. The non-transitory computer-readable medium of claim 11, wherein the first mode comprises a bytecode interpreter mode.

14. (canceled)

15. (canceled)

16. The non-transitory computer-readable medium of claim 11, wherein the array of values comprises an array of Boolean values that are initially set to true, and wherein modifying the particular value of the array comprises setting the particular value to false.

17. The non-transitory computer-readable medium of claim 11, wherein the array of values comprises an array of integer values, and wherein modifying the particular value of the array comprises setting the particular value to an integer that is indicative of a current time.

18. A computing system comprising:
a memory;
at least one processor coupled to the memory, wherein the at least one processor is configured to host a virtual machine; and
instructions stored in the memory that, when executed by the virtual machine, cause the virtual machine to perform functions comprising:
receiving portable code to be executed in one of multiple execution modes, wherein the virtual machine is configured to execute one or more individual instructions of the portable code in a higher performance mode after the individual instructions have been executed at least once in a first mode, and wherein in the higher performance mode the virtual machine is configured to execute the individual instructions with a faster speed of execution than in the first mode;
determining the number of instructions within the portable code;
generating an array of values having at least as many values as the number of instructions, wherein each instruction of the portable code is associated with a separate value in the array of values;
determining a mapping between each instruction of the portable code and a corresponding value in the array of values, wherein a value of the array of values indicates whether a given instruction of the portable code has been executed by the computing system;
based on the mapping, modifying particular values of the array of values that correspond to particular instructions of the portable code as the particular instructions are executed by the virtual machine;
identifying, without referencing the array of values, individual instructions to execute in the higher performance mode;
compiling the identified instructions into native machine code;
executing, by the virtual machine, the native machine code; and
based on the array of values and the mapping, determining which instructions of the portable code were executed at least once by the computing system.

19. (canceled)

20. (canceled)

21. The computing system of claim 18, wherein the array of values comprises an array of Boolean values that are initially set to false, and wherein modifying a particular value of the array comprises setting the particular value to true.

22. The computing system of claim 18, wherein the array of values comprises an array of integer values, and wherein modifying the particular value of the array comprises setting the particular value to an integer that is indicative of a current time.

23. The computing system of claim 18, wherein the first mode comprises a bytecode interpreter mode.
